(19) United States
(12) Patent Application Publication
(10) Pub. No.: US 2025/0012288 A1
(43) Pub. Date: Jan. 9, 2025

(54) FLUID TRANSFER APPARATUS, FLUID COOLING APPARATUS AND REFRIGERATION APPARATUS, AS WELL AS METHOD OF DETECTING STATE OF FLUID TRANSFER APPARATUS

(71) Applicant: DAIKIN INDUSTRIES, LTD., Osaka (JP)

(72) Inventors: Shimpei MIURA, Osaka (JP); Takahiro YOKOYAMA, Osaka (JP); Takeshi ARAKI, Osaka (JP); Takuro OGAWA, Osaka (JP)

(21) Appl. No.: 18/894,431

(22) Filed: Sep. 24, 2024

Related U.S. Application Data
(63) Continuation of application No. PCT/JP2023/009993, filed on Mar. 15, 2023.

(30) Foreign Application Priority Data
Mar. 30, 2022 (JP) 2022-057307

(51) Int. Cl. F04D 27/00; F04D 25/08

(52) U.S. Cl. CPC F04D 27/001; F04D 25/08; F05D 2270/3015; F05D 2270/335

(57) ABSTRACT

A fluid transfer apparatus includes a processor; a fan configured to transfer fluid along a flow path by a rotational motion; a structure provided in the flow path, the structure being configured to generate a pressure loss in the flow path as the fluid passes through the structure; and a memory storing one or more programs, which when executed, cause the processor to detect a state of the fluid or a state of the structure by monitoring a phenomenon correlated with a change in a force received by a blade of the fan from the fluid due to a disturbance of the fluid transferred along the flow path by the fan.

### CROSS-REFERENCE TO RELATED APPLICATION

The present application is a continuation application of International Application No. PCT/JP2023/009993 filed on Mar. 15, 2023, which is based on and claims priority to Japanese Patent Application No. 2022-057307 filed on Mar. 30, 2022. The contents of these applications are incorporated herein by reference in their entirety.

### TECHNICAL FIELD

The present disclosure relates to a fluid transfer apparatus, a fluid cooling apparatus and a refrigeration apparatus, and a state detecting method of the fluid transfer apparatus.

### BACKGROUND ART

Conventionally, there has been known a clogging detection device that stores the number of rotations of a motor that drives a fan, and determines that the filter is clogged when the average value Nₐᵥₑ of n rotations exceeds the reference number of rotations N₁. By obtaining the average value Nₐᵥₑ of n rotations, it is possible to reduce the influence of temperature variation of the atmosphere and power supply voltage variation (for example, see Patent Document 1).

### CITATION LIST

### Patent Document

[Patent Document 1] Japanese Unexamined Patent Application Publication No. H11-290630

### SUMMARY

The present disclosure provides a fluid transfer apparatus including:
a processor;
a fan configured to transfer fluid along a flow path by a rotational motion;
a structure provided in the flow path, the structure being configured to generate a pressure loss in the flow path as the fluid passes through the structure; and
a memory storing one or more programs, which when executed, cause the processor to:
detect a state of the fluid or a state of the structure by monitoring a phenomenon correlated with a change in a force received by a blade of the fan from the fluid due to a disturbance of the fluid transferred along the flow path by the fan.

### BRIEF DESCRIPTION OF DRAWINGS

FIG. 1 is a schematic structural view of an oil cooling apparatus according to a first embodiment;

FIG. 2 is a perspective view of an oil cooling apparatus according to the first embodiment;

FIG. 3 is a front view of an oil cooling apparatus according to the first embodiment;

FIG. 4 is a perspective view illustrating the configuration of a condenser of an oil cooling apparatus according to the first embodiment;

FIG. 5 is a partial cross-sectional view schematically illustrating the longitudinal cross-section B-B of FIG. 3;

FIG. 6 is a correlation block diagram illustrating the effects of the occurrence of a state of clogging or the like;

FIG. 7 is a diagram for explaining a first detection method of a state of clogging or the like;

FIG. 8 is a diagram illustrating the time variation of the frequency at which the spectral intensity is greatest;

FIG. 9 illustrates the time variation in spectral intensity at a specific frequency;

FIG. 10 illustrates the time variation in the current spectral intensity at a specific frequency when the pressure loss is small;

FIG. 11 illustrates the time variation in current spectral intensity at a specific frequency when the pressure loss is large;

FIG. 12 illustrates a second method of detecting a state of clogging or the like when the fan is small; and

FIG. 13 illustrates a second method of detecting a state of clogging or the like when the fan is large.

### DESCRIPTION OF EMBODIMENTS

Embodiments will be described below. In the drawings, the same reference numerals represent the same or equivalent portions. Dimensions in the drawings, such as length, width, thickness, and depth, may not represent actual relative dimensions because they are appropriately changed from actual scales for the sake of clarity and simplification of the drawings.

### First Embodiment

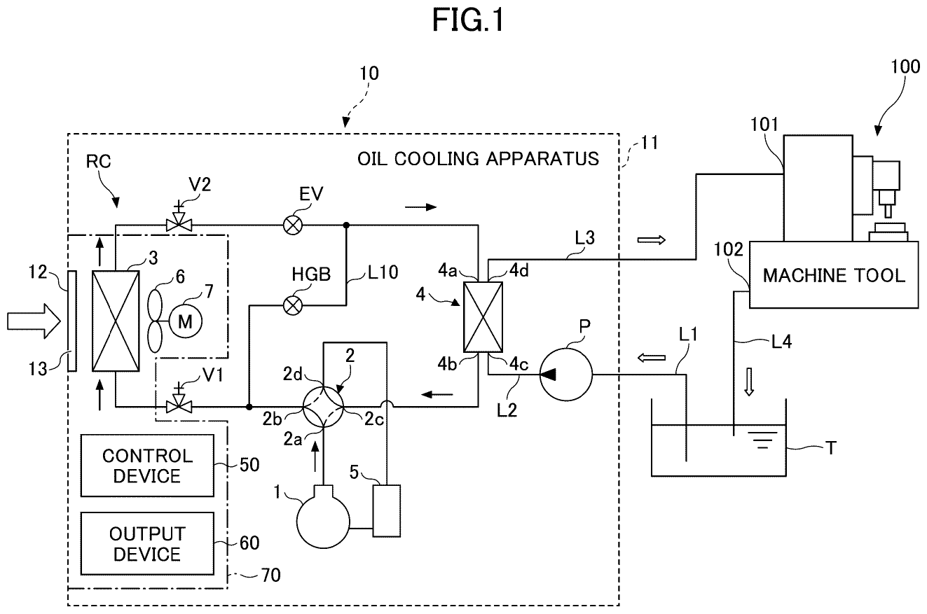

FIG. 1 is a schematic configuration diagram of an oil cooling apparatus according to the first embodiment. An oil cooling apparatus 10 illustrated in FIG. 1 is an example of a fluid cooling apparatus for cooling a fluid, and in this example, the oil cooling apparatus 10 cools oil. The oil cooling apparatus 10 illustrated in FIG. 1 cools the operating oil, the lubricating oil, or the cooling oil (hereinafter, also referred to simply as “oil”) of the machine tool 100 while circulating the oil through the oil tank T. Specific examples of the machine tool 100 include a machining center, an NC (Numerical Control) lathe, a grinding machine, an exclusive-use NC machine, and an NC electric discharge machine. The oil cooling apparatus 10 may be an apparatus for cooling oil of a machine (a molding machine, a press machine, etc.) different from the machine tool.

The oil cooling apparatus 10 includes a refrigerant circuit RC in which a compressor 1, a condenser 3, an electronic expansion valve EV, and an evaporator 4 are annularly connected, a four-way selector valve 2 for switching the refrigerant circulation direction of the refrigerant circuit RC from a positive cycle to a reverse cycle, a fan 6 for supplying air to the condenser 3, and a control device 50 for controlling the refrigerant circuit RC and the four-way selector valve 2. The control device 50 controls the fan 6, and more specifically, controls a motor 7 for rotating the fan 6. The electronic expansion valve EV is an example of a pressure reducing mechanism. The refrigerant circuit RC has a hot gas bypass pipe L10 and a hot gas bypass valve HGB arranged in the hot gas bypass pipe L10.

Although the embodiment illustrated here is an oil cooling apparatus capable of switching between a normal cycle and a reverse cycle by a four-way selector valve, the cooling cycle of the oil cooling apparatus may be a cycle without a four-way selector valve.

The refrigerant circuit RC, the four-way selector valve 2, the fan 6, and the control device 50 are housed in a housing 11.

The discharge side of the compressor 1 is connected to the first port 2a of a four-way selector valve 2. A second port 2b of the four-way selector valve 2 is connected to one end of the condenser 3 through a closing valve V1. The other end of the condenser 3 is connected to one end of the electronic expansion valve EV through a closing valve V2.

The other end of the electronic expansion valve EV is connected to one end 4a of the evaporator 4. Another end 4b of the evaporator 4 is connected to a third port 2c of the four-way selector valve 2. A fourth port 2d of the four-way selector valve 2 is connected to an intake side of the compressor 1 via an accumulator 5. The one end 4a of the evaporator 4 is connected to one end of a hot gas bypass pipe L10. The other end of the hot gas bypass pipe L10 is connected to the second port 2b of the four-way selector valve 2.

The other end of the pipe L1, one end of which is immersed in oil in the oil tank T, is connected to the intake port of the circulation pump P. The discharge port of the circulation pump P is connected to the inflow port 4c of the evaporator 4 via the pipe L2.

The outflow port 4d of the evaporator 4 is connected to one end of the pipe L3, and the other end of the pipe L3 is connected to the inflow port 101 of the machine tool 100. The outflow port 102 of the machine tool 100 is connected to the oil tank T through the pipe L4.

The oil tank T, the evaporator 4, the machine tool 100, and the pipes L1 to L4 are included in a circulation path through which oil circulates.

The oil cooling system includes an oil cooling apparatus 10 and a circulation path. In the first embodiment, the oil cooling apparatus 10 includes a circulation pump P, but the oil cooling system may include a circulation pump outside the oil cooling apparatus.

In the oil cooling operation of the oil cooling apparatus 10, the high-pressure gas refrigerant discharged from the compressor 1 flows into the condenser 3 through the four-way selector valve 2, and is then heat-exchanged with outside air in the condenser 3 to be condensed to become a liquid refrigerant. Next, the liquid refrigerant reduced in pressure in the electronic expansion valve EV flows into the evaporator 4, and is then heat-exchanged with oil and evaporated to become a low-pressure gas refrigerant, and returns to the intake side of the compressor 1 through the accumulator 5. Thus, the oil is cooled in the evaporator 4. In this oil cooling operation, the control device 50 controls the rotational frequency of the compressor 1 and the opening degree of the electronic expansion valve EV based on the temperature of the oil and the room temperature. The hot gas bypass valve HGB arranged in the hot gas bypass pipe L10 controls the cooling capability at a low load by adjusting the amount of high-temperature and high-pressure gas supplied to the evaporator 4.

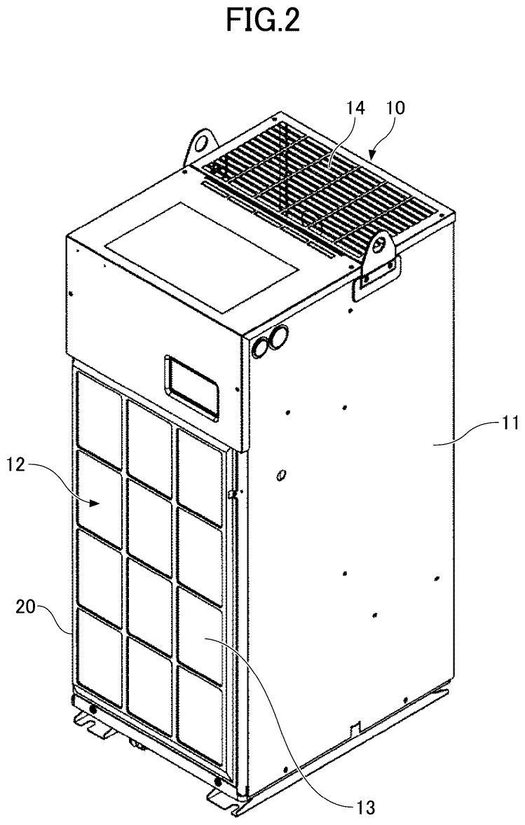

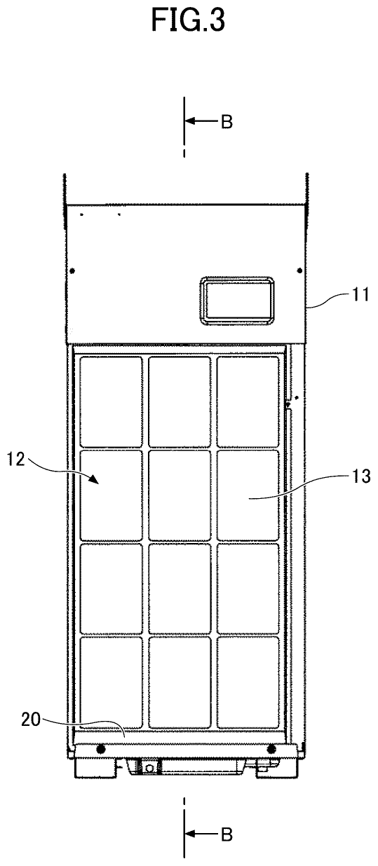

FIG. 2 is a perspective view of the oil cooling apparatus 10, and FIG. 3 is a front view of the oil cooling apparatus 10. In the example illustrated in FIGS. 2 and 3, the oil cooling apparatus 10 includes the longitudinal rectangular parallelepiped housing 11. In this example, the intake port 12 located upstream of the condenser 3 is provided on one side surface (front surface) of the housing 11, and a blowout port 14 located downstream of the condenser 3 is provided on the top surface side of the housing 11. The positions of the intake port 12 and the blowout port 14 are not limited to the above.

A filter 13 is attached to the intake port 12. The filter 13 is fixed to the housing 11 by a mounting frame 20.

The filter 13 has a filter material formed of, for example, a nonwoven fabric. The shape of the filter material may be flat, pleated, net-like, or roll-like, but is not limited thereto.

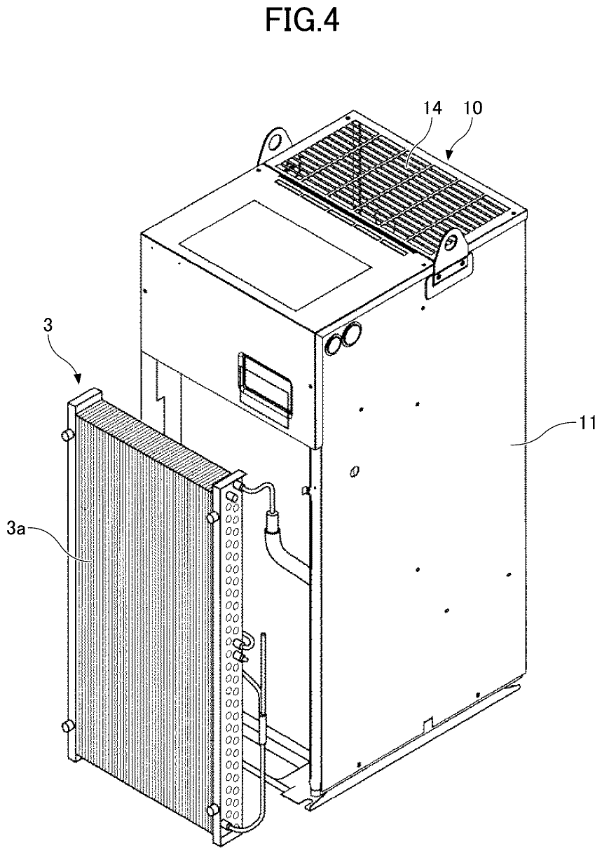

FIG. 4 illustrates a state in which the condenser 3 is removed from the housing 11. The condenser 3 has a plurality of plate-like fins 3a arranged parallel to each other and along the vertical direction.

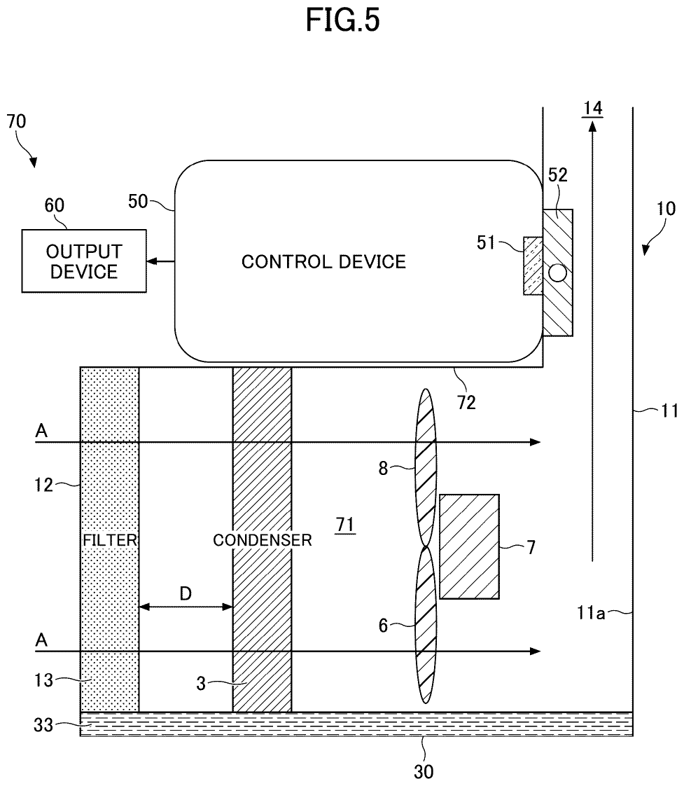

FIG. 5 is a partial cross-sectional view schematically illustrating the longitudinal cross-section B-B of FIG. 3. The filter 13, the condenser 3, and the fan 6 are arranged in the housing 11 in the order of the filter 13, the condenser 3, and the fan 6 from the intake port 12 side. The filter 13 may be attached to the intake port 12 of the housing 11 with an interval D (for example, 10 mm) with respect to the condenser 3, or may be partially or entirely in contact with the condenser 3 (interval D=0 mm).

In the oil cooling apparatus 10, outside air is taken in from the intake port 12 through the filter 13 by rotation of the fan 6, supplied to the condenser 3, and then discharged from the blowout port 14.

Depending on the environment in which the oil cooling apparatus 10 is used, air A containing foreign matter such as oil smoke (oil mist) and dust generated by the machine tool 100 may be supplied to the filter 13 or the condenser 3. When air A containing foreign matter is supplied to the filter 13 or the condenser 3, clogging of the filter 13 or the condenser 3 occurs. When clogging occurs, the ability of the oil cooling apparatus 10 to cool oil decreases, which may result in, for example, the machine tool 100 suddenly stopping or decreased processing accuracy. When clogging occurs in the condenser 3, it is necessary to remove the condenser 3 from the housing 11 and perform measures such as cleaning and replacement, resulting in a long down time and a large opportunity loss.

The oil cooling apparatus 10 according to the first embodiment of the present disclosure includes a fluid transfer apparatus 70 having a function of detecting clogging of the filter 13 or the condenser 3. The fluid transfer apparatus 70 is an apparatus for transferring air A, which is an example of fluid, from the intake port 12 to the blowout port 14. The fluid transfer apparatus 70 includes a fan 6, a motor 7, a filter 13, a condenser 3, a control device 50, and an output device 60.

The fan 6 is an example of a rotating body for transferring air A along the flow path 71 in the housing 11 by rotary driving by the motor 7. In this example, the fan 6 is arranged at a position somewhere along the flow path 71, but may be arranged at an end (e.g., blowout port 14) of the flow path 71. Air A flowing in the flow path 71 is transferred from the intake port 12 to the blowout port 14 by rotation of the fan 6. The fan 6 rotates so that air A is taken in from the intake port 12 through the filter 13, and air A filtered through the filter 13 is supplied to the condenser 3. Air A passing through the condenser 3 is discharged from the blowout port 14 by rotation of the fan 6. The fan 6 has a plurality of blades 8 rotated by driving of the motor 7. The fan 6 is, for example, an axial flow fan such as a propeller fan.

The flow path 71 is a passage through which air A flows. At least a part of the flow path 71 may be formed by a structure such as a duct arranged in the housing 11, may be formed by an inner wall 72 in the housing 11, or may be formed by a housing 11. In the example illustrated in FIG. 1, the flow path 71 is an internal space surrounded by an inner wall 72 in the housing 11, an inner surface 11a of the housing 11, and an oil reservoir 33.

The housing 11 has, for example, a bottom frame 30 that covers the lower side of the housing 11. The bottom frame 30 has an oil reservoir 33 provided below the condenser 3 and the filter 13. The oil reservoir 33 receives and stores oil droplets from the condenser 3 and the filter 13. The oil reservoir 33 is also referred to as an oil pan. The oil reservoir 33 may be formed integrally with the bottom frame 30 or may be provided separately from the bottom frame 30.

The motor 7 is an electric motor for rotating the fan 6. The rotating shaft of the motor 7 is connected directly or via a gear to the center of rotation of the fan 6. The motor 7 is controlled by the control device 50. The motor 7 may be arranged in the flow path 71 or outside the flow path 71. By arranging the motor 7 in the flow path 71, the motor 7 can be cooled by air A.

The filter 13 is an example of a structure provided in the flow path 71 and having a path through which air A passes. The filter 13 is a structure through which air A passes and filters the air A. The filter 13 may be provided at an end (for example, the open end of the flow path 71, more specifically, the intake port 12) of the flow path 71 or in the middle (e.g., within the duct forming the flow path 71) of the flow path 71. For example, when the filter 13 is made of a nonwoven fabric, the gap between the fibers of the nonwoven fabric corresponds to a passage through which air A passes.

The condenser 3 is an example of a structure provided in the flow path 71 and having a passage through which air A passes. The condenser 3 is a structure through which air A passes, and is provided at a position somewhere along the flow path 71. The condenser 3 is a heat exchanger that liquefies a high-pressure, high-temperature gas refrigerant by exchanging heat with air A. In the illustrated example, the condenser 3 is arranged between the filter 13 and the fan 6. The gap between the plurality of fins 3a arranged as illustrated in FIG. 4 corresponds to a passage through which air A passes.

In FIG. 5, the control device 50 has a driving circuit 51 that drives the motor 7 by switching a plurality of semiconductor switching elements. The driving circuit 51 supplies a drive current to the motor 7, and the motor 7 rotates the fan 6 when the drive current is supplied from the driving circuit 51. The driving circuit 51 is, for example, an inverter circuit that converts a direct current from a direct current source into an alternating current that is supplied to the motor 7.

The heat of the driving circuit 51 is transferred to the heat sink 52. Because the heat sink 52 is arranged in the flow path 71, the heat sink 52 is cooled by the air A, and the heat dissipation effect of the heat sink 52 on the driving circuit 51 is improved. In the illustrated example, the control device 50 is separated from the flow path 71 by the inner wall 72, but the control device 50 may be arranged in the flow path 71. The driving circuit 51 may be arranged at a different location from the control device 50.

The filter 13 is a structure that generates a pressure loss in the flow path 71 when the air A passes through the filter 13. Similarly, the condenser 3 is a structure that generates a pressure loss in the flow path 71 when the air A passes through the condenser 3.

When the control device 50 controls the rotation speed of the fan 6 or the motor 7 to be constant, the average rotation speed of the fan 6 becomes constant, although the rotation speed of the fan 6 fluctuates slightly. On the other hand, as the clogging of the filter 13 or the condenser 3 worsens, the pressure loss in the flow path 71 increases. When the pressure loss in the flow path 71 increases, the degree of disturbance of the air A transferred by the fan 6 along the flow path 71 increases. The disturbance refers to a state in which the flow direction of the fluid, the flow velocity of the fluid, or the pressure of the fluid fluctuates irregularly. The flow direction of the fluid and the flow velocity of the fluid can be measured by using, for example, a flow velocity sensor (electromagnetic type, ultrasonic type, Karman vortex type, thermal type, etc.) or the like, or particle image velocimetry (PIV). The pressure of the fluid can be measured by using, for example, a strain gauge sensor or the like. When the control device 50 controls the rotation speed of the fan 6 or the motor 7 to be constant in a state in which the air A is disturbed, the average rotation speed of the fan 6 does not appreciably change. However, the variation of the load on the fan 6 changes due to the disturbance whose degree is increased by the increase of the pressure loss due to clogging, resulting in an increase in the degree of variation of the rotation speed of the fan 6.

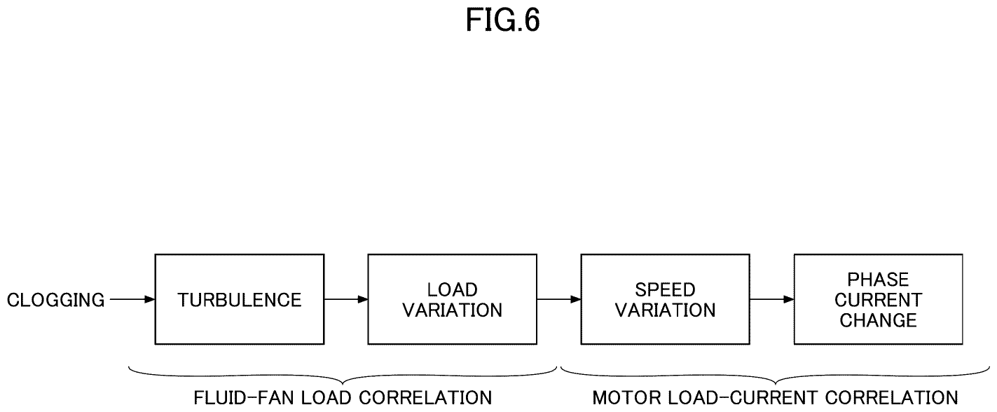

FIG. 6 is a correlation block diagram illustrating the influence of a state of clogging or the like. When a state of clogging or the like occurs in the filter 13 or the condenser 3, the degree of turbulence (disturbance) of the air A in the flow path 71 increases. When the blades 8 of the fan 6 are disturbed by the air A, the variation of the force F applied to the blades 8 (variation of the load applied to the fan 6) is disturbed. The variation of the load variation of the fan 6 increases the variation of the rotation speed of the fan 6, although the average rotation speed of the fan 6 is constant. When the variation of the rotation speed of the fan 6 increases, the variation of the phase current flowing through the motor 7 that drives the fan 6 also increases.

Thus, when the state of the air A transferred by the fan 6 along the flow path 71 or the state of the structure through which the air A passes significantly changes, the degree of disturbance of the air A transferred by the fan 6 along the flow path 71 increases. The force F exerted on the blade 8 of the fan 6 by the air A fluctuates due to the disturbance of the air A.

By focusing on this correlation, the control device 50 illustrated in FIG. 5 functions as a detecting unit that monitors a phenomenon correlated with the variation of the force F due to the disturbance of the air A and detects, for example, the state of the air A or the state of the structure through which the air A passes. The variation of the force F due to the disturbance of the air A means a state in which the variation of the force F increases due to the disturbance of the air A. Because the control device 50 has such a function as a detecting unit, it is possible to detect the state of the fluid such as the disturbance of the air A or the state of the structure such as the clogging of the filter 13 or the condenser 3 with high accuracy by monitoring the phenomenon correlated with the variation of the force F caused by the disturbance of the air A.

As the phenomenon correlated with the variation of the force F caused by the disturbance of the air A, there is a change in the current, voltage, or power of the motor 7 which drives the fan 6. The control device 50 may detect the state of the fluid such as the disturbance of the air A or the state of the structure such as the clogging of the filter 13 or the condenser 3 by monitoring, for example, the change in the phase current flowing through the motor 7 with the current sensor. The control device 50 may detect the state of the fluid such as the disturbance of the air A or the state of the structure such as the clogging of the filter 13 or the condenser 3 by monitoring, for example, the change in the voltage generated in the motor 7 with the voltage sensor. The control device 50 may detect the state of the fluid such as the disturbance of the air A or the state of the structure such as the clogging of the filter 13 or the condenser 3 by monitoring, for example, the change in the power input/output to the motor 7 with the current sensor and the voltage sensor. Because the current sensor and the voltage sensor for detecting the current, voltage, and power of the motor 7 are already provided for fan control, it is not necessary to separately provide the aforementioned flow velocity sensor or the like in order to detect the disturbance of the air A, so that there is no need for additional cost for implementing this configuration.

As a phenomenon correlated with the change in the force F caused by the disturbance of the air A, there is a change in the rotation speed of the fan 6. The control device 50 may detect the state of the fluid such as the disturbance of the air A or the state of the structure such as the clogging of the filter 13 or the condenser 3 by monitoring, for example, the change in the rotation speed of the fan 6 (more specifically, the magnitude of the pulsation of the rotation speed of the fan 6) with the sensor.

As a phenomenon correlated with the variation of the force F caused by the disturbance of the air A, there is a change in sound or vibration generated by the rotational motion of the fan 6. The control device 50 may detect, for example, the state of a fluid such as the disturbance of the air A or the state of a structure such as the clogging of the filter 13 or the condenser 3 by monitoring the change in sound or vibration generated by the rotational motion of the fan 6 with a sensor.

As described above, when the magnitude of the pressure loss generated in the flow path 71 changes, the degree of the disturbance of the air A increases and the variation of the force F increases. By focusing on this feature, the control device 50 may detect a quantity correlated with the magnitude of the pressure loss generated in the flow path 71 by monitoring the phenomenon correlated with the variation of the force F caused by the disturbance of the air A.

The control device 50 is a control unit including, for example, a processor such as a CPU (Central Processing Unit) and a memory. The function of the control device 50 is implemented by causing the processor to operate by a program stored in the memory. The function of the control device 50 may be implemented by an FPGA (Field Programmable Gate Array) or an ASIC (Application Specific Integrated Circuit).

The output device 60 is an example of an output unit for outputting detection information indicating the state of the air A detected by the control device 50 or the state of the structure through which the air A passes. The output device 60 outputs detection information to the outside of the fluid transfer apparatus 70 by, for example, sound, light, display, communication, or any combination thereof. Specific examples of the output device 60 include a speaker, a lamp, a display, a communication device, or a combination thereof.

Thus, according to the fluid transfer apparatus 70, the output device 60 outputs detection information when the state of the air A detected by the control device 50 or the state of the structure through which the air A passes satisfies a predetermined condition. Because the detection information is output by the execution of the above state detection method by the fluid transfer apparatus 70, for example, the occurrence of clogging in the filter 13 or the condenser 3 can be detected.

Because clogging in the filter 13 or the condenser 3 can be detected, for example, maintenance work of the filter 13 or the condenser 3 can be facilitated, and an increase in hours labored and costs for management and maintenance can be prevented. Further, because clogging in the filter 13 or the condenser 3 can be detected, prior measures such as cleaning or replacement of the filter 13 or the condenser 3 can be taken before a malfunction such as a decrease in the oil cooling capability of the oil cooling apparatus 10 occurs.

The output device 60 may report the detection information to a user or an external device. Thus, the user or the external device can recognize the clogging of the filter 13 or the condenser 3.

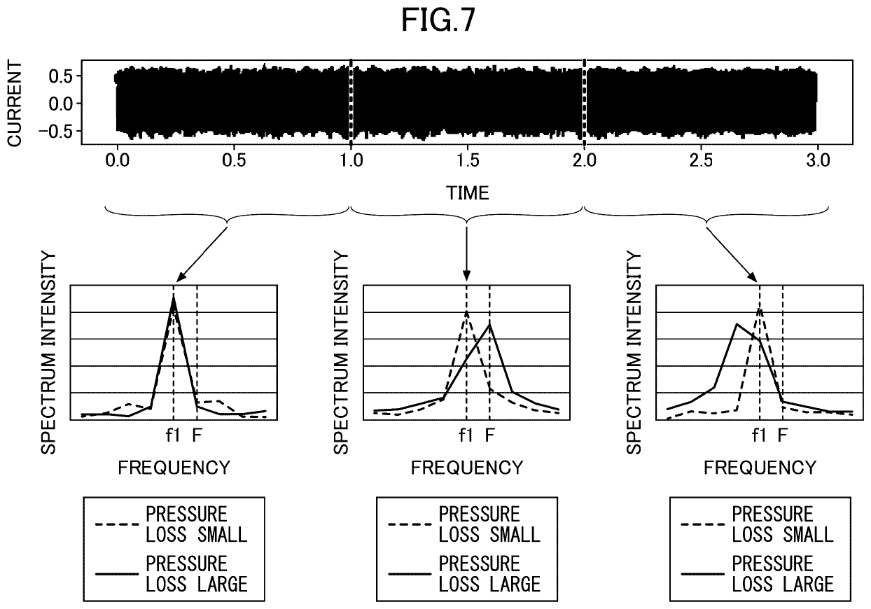

FIG. 7 is a diagram for explaining the first detection method of the clogging. The current waveform in the upper part of FIG. 7 represents the transition of the phase current for 3 seconds flowing through the motor 7 for rotationally driving the fan 6 in response to a predetermined rotation speed instruction. The control device 50 performs Fast Fourier Transform (FFT) on the phase current detected by the current sensor at predetermined intervals (In this example, every second). The three frequency spectra in the lower part of FIG. 7 represent the results of FFT on the phase current at predetermined intervals. In the legend, the large pressure loss and the small pressure loss represent the pressure loss in the flow path 71. The larger the pressure loss in the flow path 71, the more severe the clogging.

As illustrated by the three frequency spectra in the lower part of FIG. 7, when the state of the air A transferred by the fan 6 along the flow path 71 or the state of the structure through which the air A passes significantly changes, the frequency spectrum changes in a manner corresponding to the change. Therefore, the control device 50 can detect the state of the air A transferred by the fan 6 along the flow path 71 or the state of the structure through which the air A passes with high accuracy by monitoring the change in the frequency spectrum of the current, voltage, or power of the motor 7 when the fan 6 is driven.

For example, the control device 50 may detect the state of the air A or the state of the structure through which the air A passes by monitoring the change in the spectrum when the frequency with the largest spectral intensity changes. The frequency with the largest spectral intensity may not be the frequency with the largest spectral intensity within all frequencies, but may be the frequency with the largest spectral intensity within the frequency of the machine angular frequency of the motor 7×N±a (a<the machine angular frequency/20). For example, when the pressure loss is large due to clogging of the structure, a phenomenon P occurs in which the spectral intensity of the frequency f1 becomes largest in the frequency spectrum of the first period, the spectral intensity of the frequency (f1+a1) becomes largest in the frequency spectrum of the second period different from the first period, and the spectral intensity of the frequency (f1−a2) becomes largest in the frequency spectrum of the third period different from the first and second periods. The notations of a1 and a2 represent frequency change components. The phenomenon P is an example of a phenomenon in which the frequency with the largest spectral intensity varies.

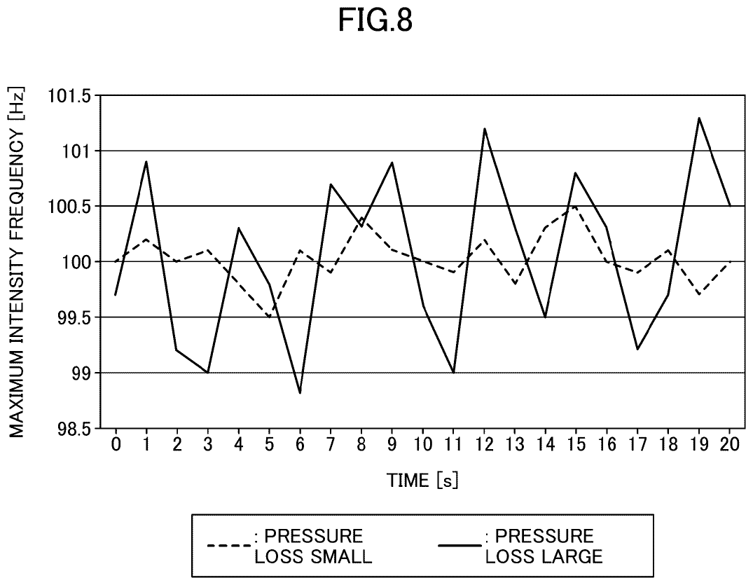

FIG. 8 is a diagram illustrating a time variation of the frequency (maximum intensity frequency) at which the spectral intensity becomes maximum. When clogging occurs, the pressure loss increases, and the phenomenon P occurs, the width (range R), in which the frequency at which the spectral intensity becomes maximum fluctuates, increases.

The control device 50 can detect, for example, the state of air A or the state of a structure through which air A passes by monitoring the difference in the range R when phenomenon P occurs. The control device 50 detects that a state of clogging or the like has occurred when the range R is greater than or equal to or equal to a predetermined threshold value. On the other hand, the control device 50 detects that a state of clogging or the like has not occurred when the range R is less than a predetermined threshold value.

The control device 50 can detect, for example, the state of air A or the state of a structure through which air A passes by monitoring the difference in the extreme value of the maximum intensity frequency when phenomenon P occurs. The control device 50 detects that a state of clogging or the like has occurred when the maximum value of the maximum intensity frequency when phenomenon P occurs is greater than or equal to a predetermined first frequency fa, or when the minimum value of the maximum intensity frequency when phenomenon P occurs is less than or equal to a predetermined second frequency fb (fb<fa). On the other hand, the control device 50 detects that a state of clogging or the like has not occurred when the maximum value of the maximum intensity frequency when phenomenon P occurs is less than a predetermined first frequency fa, and when the minimum value of the maximum intensity frequency when phenomenon P occurs exceeds a predetermined second frequency fb.

When the phenomenon P occurs, for example, the spectral intensity at a predetermined frequency (f1+a1) changes for each of the first to third three periods. Therefore, the control device 50 can detect the state of the air A or the state of the structure through which the air A passes by monitoring the change (difference) of the spectral intensity at a predetermined frequency (f1+a1) when the phenomenon P occurs.

The control device 50 may monitor the change of the spectral intensity of the phase current at a specific frequency F. The specific frequency F is set within, for example, the machine angular frequency of the motor 7×N (N is a natural number)±a (a<the machine angular frequency/20). In the example illustrated in FIG. 7, the machine angular frequency of the motor 7 is f1. As illustrated in the three frequency spectra illustrated in the lower part of FIG. 7, the change of the spectral intensity of the phase current at the specific frequency F is larger for the frequency spectrum in which the pressure loss in the flow path 71 is larger. The control device 50 monitors the change of the spectral intensity of the phase current at the specific frequency F, and can detect the state of the air A or the state of the structure through which the air A passes according to the difference of the spectral intensity of the phase current at the specific frequency F.

The control device 50 may monitor a change in the spectral intensity of the current vector amplitude (that is, the direct current (DC) amount D correlated with the torque of the motor 7) at a specific frequency F. The current vector amplitude is represented by the square root of the sum of squares of the phase currents of all phases flowing through the motor 7. In this case, the specific frequency F is set within, for example, the machine angular frequency of the motor 7×the number of blades 8×N (N is a natural number)±a (a<the machine angular frequency/20). The control device 50 acquires the frequency spectrum of the current vector at each predetermined period by performing the Fast Fourier Transform (FFT) of the DC amount D correlated with the torque of the motor 7 at each predetermined period. In the case of the frequency spectrum of the current vector, the peak of the spectral intensity of the current vector appears at the frequency component of (the machine angular frequency of the motor 7×the number of blades 8×N). For the frequency spectrum with the greater pressure loss in the flow path 71, the change in the spectral intensity of the current vector at the specific frequency F will be greater. The control device 50 monitors the change in the current spectrum at the specific frequency F, and can detect the state of the air A or the state of the structure through which the air A passes according to the difference in the spectral intensity of the current vector at the specific frequency F.

The DC amount D correlated with the torque of the motor 7 may be, in addition to the current vector amplitude, the square value of the current vector amplitude, the amplitude or the actual value of the phase current flowing through the motor 7, or the current obtained by converting the α-axis current and the β-axis current obtained by converting the phase current flowing through the motor 7 into three phases and two phases, into rotational coordinates by an angle based on the primary magnetic flux or the direction of the magnetic pole of the rotor of the motor 7.

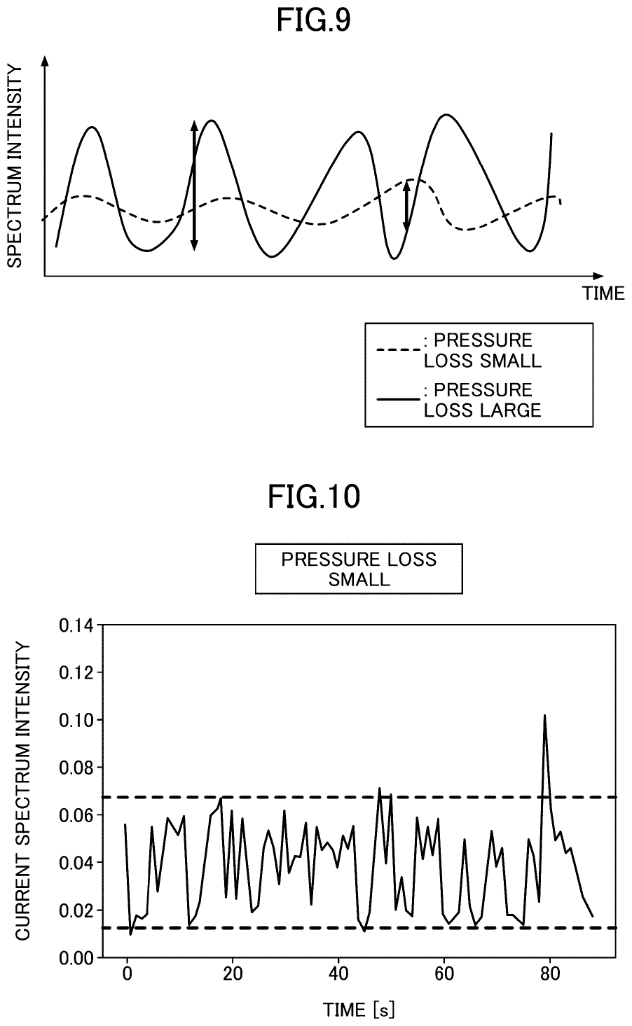

FIG. 9 is a diagram illustrating time variations in the spectral intensity at the specific frequency F. Looking at time variations in the current spectral intensity at the specific frequency F, the larger the pressure loss, the larger the change range of the current spectral intensity. When the spectral intensity at the specific frequency F fluctuates more than a predetermined variation range, the control device 50 detects that a state of clogging or the like has occurred. When the spectral intensity at the specific frequency F fluctuates less than a predetermined variation range, the control device 50 detects that a state of clogging or the like has not occurred.

The number of the specific frequencies F used for determining the state of clogging or the like is not limited to one, but may be plural. The frequency spectrum used by the control device 50 for determining the state of clogging or the like is not limited to the frequency spectrum of the current of the motor 7, but may be the frequency spectrum of the voltage or power of the motor 7.

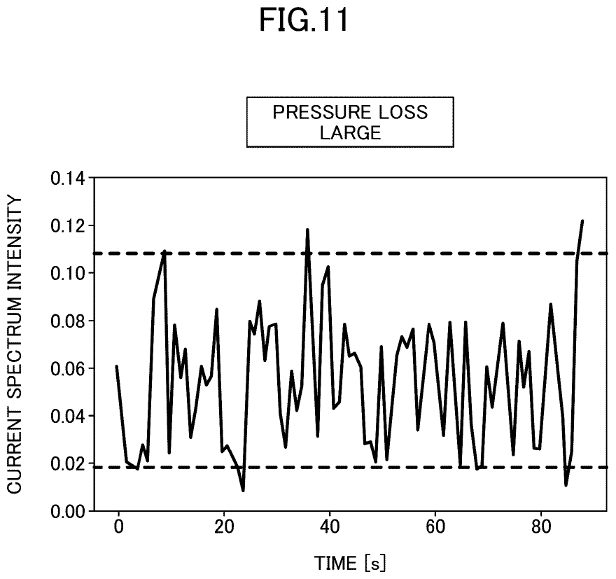

FIG. 10 is a diagram illustrating time variations in the current spectral intensity at the specific frequency F of 99 Hz when the pressure loss in the flow path 71 is small. FIG. 11 is a diagram illustrating time variations in the current spectral intensity at the specific frequency F of 99 Hz when the pressure loss in the flow path 71 is large.

The control device 50 evaluates time variations in the current spectrum intensity at a specific frequency F of 99 Hz. As the state of clogging or the like worsens, the variation range of the current spectrum intensity in a predetermined period widens. If the variation range of the current spectrum intensity in the predetermined period is smaller than the predetermined variation range (predetermined threshold) (FIG. 10), the control device 50 determines that the state of clogging or the like has not occurred. On the other hand, if the variation range of the current spectrum intensity in the predetermined period is larger than the predetermined variation range (predetermined threshold) (FIG. 11), the control device 50 determines that the state of clogging or the like has occurred.

In order to reduce the detection error of the variation range of the current spectrum intensity, one or more upper current spectra and one or more lower current spectra may be removed from the variation range of the current spectrum intensity. Further, in order to reduce the detection error of the variation range of the current spectrum intensity, the variation range of the current spectrum intensity may be measured from the effective value of the current spectrum intensity.

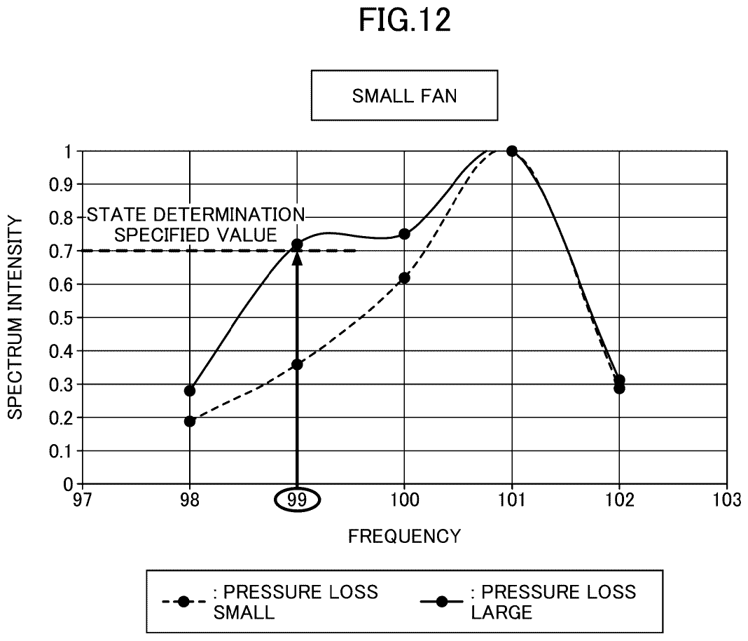

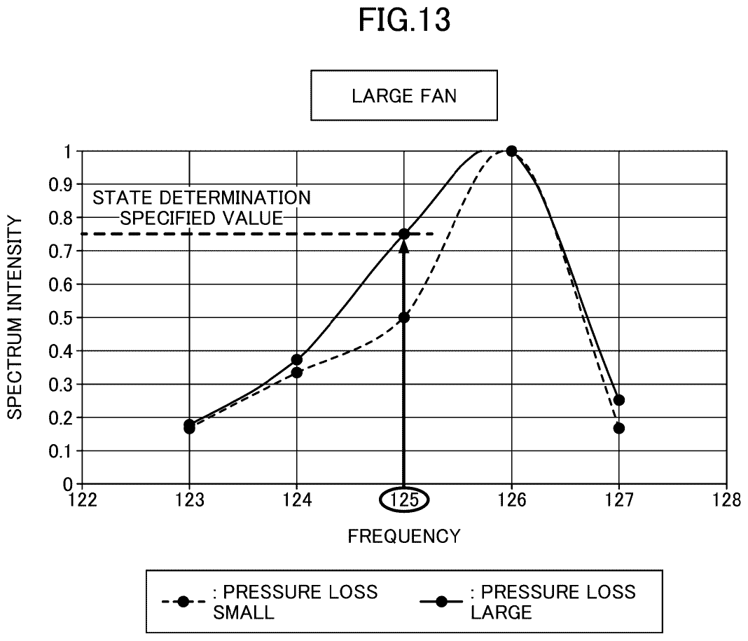

FIG. 12 is a diagram for explaining a second detection method of the state of clogging or the like when the fan 6 is small. FIG. 13 is a diagram for explaining a second detection method of a state of clogging or the like when the fan 6 is large. When the rotation speed of the fan 6 is constant (specifically, when the fan 6 is rotating at a constant instructed rotation speed), the current spectrum intensity of only the rotational frequency (101 Hz for FIG. 12; in FIG. 13, 126 Hz) of the fan 6 should increase. However, when the rotation speed of the fan 6 is fluctuating due to a disturbance of the fluid caused by a change in the pressure loss in the flow path 71, a difference occurs in the current spectrum intensity at a specific frequency (99 Hz for FIG. 12; in FIG. 13, 125 Hz) different from the rotational frequency of the fan 6. When the current spectrum intensity at a specific frequency different from the rotational frequency of the fan 6 exceeds a predetermined state determination specified value, the control device 50 determines that a state of clogging or the like has occurred. On the other hand, when the current spectrum intensity at a specific frequency different from the rotational frequency of the fan 6 is lower than a predetermined state determination specified value, the control device 50 determines that a state of clogging or the like has not occurred.

### Second Embodiment

The fluid transfer apparatus may be applied to a fluid cooling apparatus for cooling a liquid different from oil. The fluid cooling apparatus of the second embodiment may have the same configuration and effect as the oil cooling apparatus 10 of the first embodiment. A description of the same configuration and effect as the oil cooling apparatus 10 of the first embodiment will be omitted by referring to the above description. The fluid cooling apparatus of the second embodiment is, for example, an apparatus for cooling the cutting fluid of the machine tool 100. The fluid cooling apparatus is a kind of refrigeration apparatus for cooling a fluid.

### Third Embodiment

The fluid transfer apparatus may be applied to a gas cooling apparatus for cooling a gas. The gas cooling apparatus of the third embodiment may have the same configuration and effect as the oil cooling apparatus 10 of the first embodiment. A description of the same configuration and effect as the oil cooling apparatus 10 of the first embodiment will be omitted by referring to the above description. The gas cooling apparatus of the third embodiment is, for example, an air conditioner for an air conditioning operation of at least one of cooling and heating. In this case, the heat exchanger to which the fluid is supplied may be a heat exchanger functioning as a condenser or a heat exchanger functioning as an evaporator. The state determination of the structure in the third embodiment may be a clogging determination of the heat exchanger or a clogging determination of a filter for preventing clogging of heat exchange. The clogging determination of the heat exchanger may be performed when frost builds up on the evaporator. The gas cooling apparatus is a kind of refrigeration apparatus for cooling a fluid.

Although the embodiments have been described above, it will be understood that various changes in form and details can be made without departing from the spirit and scope of the claims. Various modifications and improvements such as combination with or replacement with some or all of the other embodiments are possible.

For example, the flow path through which the fluid flows is not limited to a flow path inside the housing, as long as the flow path is partitioned by a partition, but may be a flow path inside a member different from the housing, for example, a flow path (hollow portion) inside a tube such as a duct.

The fluid transferred along the flow path may be a gas other than air, or a liquid such as water or oil, for example. That is, the fluid transfer apparatus may be an apparatus transferring a gas other than air, or a liquid such as water or oil, for example, as long as the fluid is transferred along the flow path by the rotation of a fan.

The structure provided in the flow path is not limited to a filter or a condenser, and may be other structures such as an evaporator.

A detecting unit such as the control device 50 detects the state of the air A or the state of the structure through which the air A passes by monitoring a phenomenon correlated with the variation of the force F caused by the disturbance of the air A. The detecting unit detects a quantity correlated with the magnitude of the pressure loss generated in the flow path as the state of the air A to be detected by monitoring the phenomenon, and may detect a failure of the fan 6 such as breakage of the blade 8 based on the quantity. The detecting unit detects a quantity correlated with the magnitude of the pressure loss generated in the flow path, and may perform air volume control, pressure control, or rotation speed control based on the PQ characteristic (P: static pressure, Q: flow rate) of the fan without using an air volume sensor or a pressure sensor based on the quantity.

What is claimed is:

1. A fluid transfer apparatus comprising:
a processor;
a fan configured to transfer fluid along a flow path by a rotational motion;
a structure provided in the flow path, the structure being configured to generate a pressure loss in the flow path as the fluid passes through the structure; and
a memory storing one or more programs, which when executed, cause the processor to:
detect a state of the fluid or a state of the structure by monitoring a phenomenon correlated with a change in a force received by a blade of the fan from the fluid due to a disturbance of the fluid transferred along the flow path by the fan.

2. The fluid transfer apparatus according to claim 1, wherein the state of the fluid detected by the processor includes an amount correlated with a magnitude of the pressure loss generated in the flow path.

3. The fluid transfer apparatus according to claim 1, wherein the state of the structure detected by the processor includes clogging of the structure.

4. The fluid transfer apparatus according to claim 1, wherein the phenomenon is a change in a current, a voltage, or a power of a motor driving the fan.

5. The fluid transfer apparatus according to claim 1, wherein the phenomenon is a change in a rotation speed of the fan.

6. The fluid transfer apparatus according to claim 1, wherein the phenomenon is a change in sound or vibration caused by the rotational motion of the fan.

7. The fluid transfer apparatus according to claim 4, wherein the phenomenon is a change in a frequency spectrum of the current, the voltage, or the power of the motor driving the fan.

8. The fluid transfer apparatus according to claim 7, wherein the change in the frequency spectrum is a change associated with a change in a frequency of a highest spectral intensity.

9. The fluid transfer apparatus according to claim 7, wherein the change in the frequency spectrum is a change in a spectral intensity of the current at a specific frequency within a machine angular frequency of the motor×N (N being a natural number)±a (a<the machine angular frequency/20).

10. The fluid transfer apparatus according to claim 9, wherein the current is a direct current amount correlated with a torque of the motor.

11. The fluid transfer apparatus according to claim 7, wherein
the current is a direct current amount correlated with a torque of the motor, and
the change in the frequency spectrum is a change in a spectral intensity of the current at a specific frequency within a machine angular frequency of the motor×a number of blades of the fan×N (N being a natural number)±a (a<the machine angular frequency/20).

12. A fluid transfer apparatus comprising:
a processor;
a fan configured to transfer fluid along a flow path by a rotational motion;
a structure provided in the flow path, the structure being configured to generate a pressure loss in the flow path as the fluid passes through the structure; and
a memory storing one or more programs, which when executed, cause the processor to:
detect a state of the fluid or a state of the structure by monitoring a change in a frequency spectrum of a current, a voltage, or a power of a motor driving the fan, the change being a change in the frequency spectrum associated with a change in a frequency of a highest spectral intensity.

13. The fluid transfer apparatus according to claim 12, wherein the change in the frequency spectrum is a change in a spectral intensity of the current at a specific frequency within a machine angular frequency of the motor×N (N being a natural number)±a (a<the machine angular frequency/20).

14. The fluid transfer apparatus according to claim 13, wherein the current is a direct current amount correlated with a torque of the motor.

15. The fluid transfer apparatus according to claim 12, wherein
the current is a direct current amount correlated with a torque of the motor, and
the change in the frequency spectrum is a change in a spectral intensity of the current at a specific frequency within a machine angular frequency of the motor×a number of blades of the fan×N (N being a natural number)±a (a<the machine angular frequency/20).

16. A fluid transfer apparatus comprising:
a processor;
a fan configured to transfer fluid along a flow path by a rotational motion;
a structure provided in the flow path, the structure being configured to generate a pressure loss in the flow path as the fluid passes through the structure; and
a memory storing one or more programs, which when executed, cause the processor to:
detect a state of the fluid or a state of the structure based on a magnitude of pulsation of a rotation speed of the fan.

17. A refrigeration apparatus comprising the fluid transfer apparatus according to claim 1.

18. A fluid cooling apparatus comprising the fluid transfer apparatus according to claim 1.

19. A method of detecting a state of a fluid transfer apparatus, the fluid transfer apparatus including:
a fan configured to transfer fluid along a flow path by a rotational motion; and
a structure provided in the flow path, the structure being configured to generate a pressure loss in the flow path as the fluid passes through the structure, the method comprising:
detecting a state of the fluid or a state of the structure by monitoring a phenomenon correlated with a change in a force received by a blade of the fan from the fluid due to a disturbance of the fluid transferred along the flow path by the fan.
